(19) United States
(12) Patent Application Publication
(10) Pub. No.: US 2025/0203444 A1
(43) Pub. Date: Jun. 19, 2025

(54) HYBRID TRAFFIC AND CHANNEL MANAGEMENT IN PROVISIONED MULTI-LINK OPERATION

(71) Applicant: QUALCOMM Incorporated, San Diego, CA (US)

(72) Inventors: Aditya SATHISH, Sunnyvale, CA (US); Gyanranjan HAZARIKA, Milpitas, CA (US); Krishnakumar MUTHUSAMY, Danville, CA (US); Sandip HOMCHAUDHURI, San Jose, CA (US)

(21) Appl. No.: 18/539,615

(22) Filed: Dec. 14, 2023

(51) Int. Cl. H04W 28/02; H04L 41/5009; H04W 36/26

(52) U.S. Cl. CPC H04W 28/0268; H04L 41/5009; H04W 28/0289; H04W 36/26

(57) ABSTRACT

This disclosure provides techniques that may enable an AP to perform hybrid channel management, in which the AP considers a service metric (e.g., QoS/SLA) to adjust a set of channels of a client when a breach condition is detected.

### TECHNICAL FIELD

This disclosure relates generally to wireless communication, and more specifically, to techniques that enable a network to perform channel management, based on a service metric, to mitigate breach conditions.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In wireless systems (such as IEEE 802.11 compliant networks), wireless stations (STAs) may be capable of multi-link operation (MLO), in which a STA associates with an access point (AP) over multiple links (e.g., 2.4, 5, and 6 GHz links). In some cases, such a non-AP multi-link device (MLD) may be provisioned to operate on only one link or a subset of links, rather than all available links. A non-AP MLD may be provisioned in such a manner, for example, to map all traffic to a particular link using to satisfy a requirement of a service level agreement (SLA) sensitive client based on a user application or a certain algorithm like load-balancing or quality of service (QOS) management. Unfortunately, in some systems that provision clients in this manner, if a breach condition arises (e.g., that causes violation of an SLA obligation), there may be limited options to mitigate the breach condition.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication at a first wireless node. The method includes provisioning a second wireless node for communication via a subset of multiple links with which the first wireless node is associated; detecting a breach condition; and performing one or more actions, after detecting the breach condition, to adjust a set of channels used for communicating with the second wireless node via the subset of multiple links, wherein the adjustment is based on at least one service metric.

Other aspects provide: an apparatus (e.g., wireless node/wireless station/wireless access point/wireless communication device) operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 depicts a block diagram of an example multi-link device (MLD) deployment.

FIG. 3 depicts an example of a provisioned MLD scenario.

FIG. 4 depicts an example call flow diagram illustrating hybrid channel management, in accordance with aspects of the present disclosure.

FIGS. 5-8 depicts example MLD scenarios with hybrid channel management, in accordance with aspects of the present disclosure.

FIG. 9 depicts a flowchart illustrating an example method for wireless communication.

FIG. 10 depicts a block diagram of an example wireless communications device.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Aspects of the present disclosure provide apparatuses, methods, processing systems, and computer-readable mediums for hybrid channel management, based on a service metric, to mitigate breach conditions.

Multi-link operation (MLO) generally refers to a mode of operation in which a STA associates with an access point (AP) over multiple links (e.g., 2.4, 5, and 6 GHZ links). MLO may be considered an enhanced feature in advanced wireless systems (e.g., such as that defined by the IEEE 802.11-2020 specification or amendments thereof including, but not limited to 802.11be Extremely High Throughput (EHT) and the 802.11 amendment associated with Wi-Fi 8)) that enables the utilization of multiple links using individual frequency channels to transmit and receive between devices. MLO may enable concurrent utilization of multiple radio links of different frequency channels/bands by an AP, a client, or both. A device capable of MLO is generally referred to as a multi-link device (MLD).

As noted above, a non-AP MLD may be provisioned to operate on only one link or a subset of links, rather than all available links. A non-AP MLD may be provisioned in such a manner, for example, to map all traffic to a particular link to satisfy a requirement of a service level agreement (SLA) sensitive client based on a user application or a certain algorithm like load-balancing or quality of service (QOS) management.

Unfortunately, in some systems that provision clients in this manner, if a breach condition arises (e.g., that causes violation of an SLA obligation), there may be limited options to mitigate the breach condition. For example, the limited options may include an AP moving a client to another link (provided the new link can support the client with its available airtime) or the AP may be able to move the client to an Multi-Link, Multi-Radio (MLMR) mode, which may result in a loss of the advantages of provisioning (e.g., improved latency using link selection). As a result, provisioned MLO may make it challenging to manage client SLA/QOS requirements effectively.

To address this issue, techniques disclosed herein may enable an AP to perform hybrid channel management, in which the AP considers a service metric (e.g., QoS/SLA) to adjust a set of channels of a client when a breach condition is detected. For example, the AP may move the client to other channels within a same link or to another link. The channels may be selected based on various metrics, such as other BSS (OBSS) loading, available airtime, and the like.

Particular aspects of the subject matter described in this disclosure can be implemented to realize one or more of the following potential advantages. In some examples, hybrid channel management proposed herein may help overcome shortcomings of provisioned MLO, which may help make a provisioned MLO algorithm more robust. As will be described in greater detail below, the hybrid channel management proposed herein may allow for further degrees of freedom to better maintain the SLA guarantees in a dynamic wireless medium for traffic flows associated with an AP.

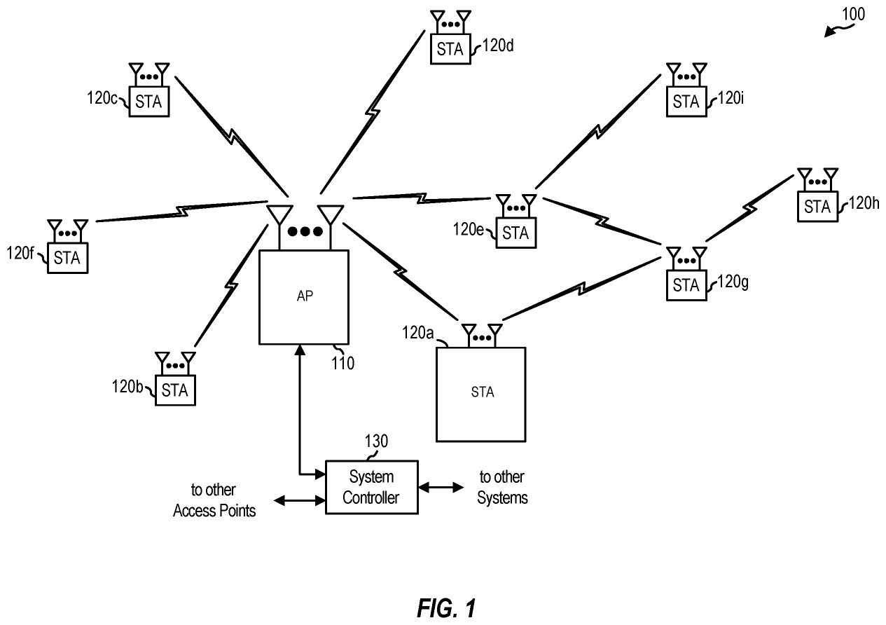

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (CNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHZ, 6 GHZ, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN 100 may transmit PPDUs over an unlicensed spectrum, which may be a portion of spectrum that includes frequency bands traditionally used by Wi-Fi technology, such as the 2.4 GHz, 5 GHZ, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHZ), FR3 (7.125 GHZ-24.25 GHZ), FR4a or FR4-1 (52.6 GHz-71 GHz), FR4 (52.6 GHz-114.25 GHZ), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHZ, 160 MHz, 240 MHZ, 320 MHZ, 480 MHz, or 640 MHz by bonding together multiple 20 MHz channels.

### Overview of Multi-Link Devices

A multi-link device (MLD) generally refers to a single device or equipment that includes two or more station (STA) instances or entities, implemented in a physical (PHY)/medium access control (MAC) layer and configured to communicate on separate wireless links. In some examples, each MLD may include a single higher layer entity, such as a MAC Service Access Point (SAP) that may assign MAC protocol data units (MPDUs) for transmission by the separate STA instances.

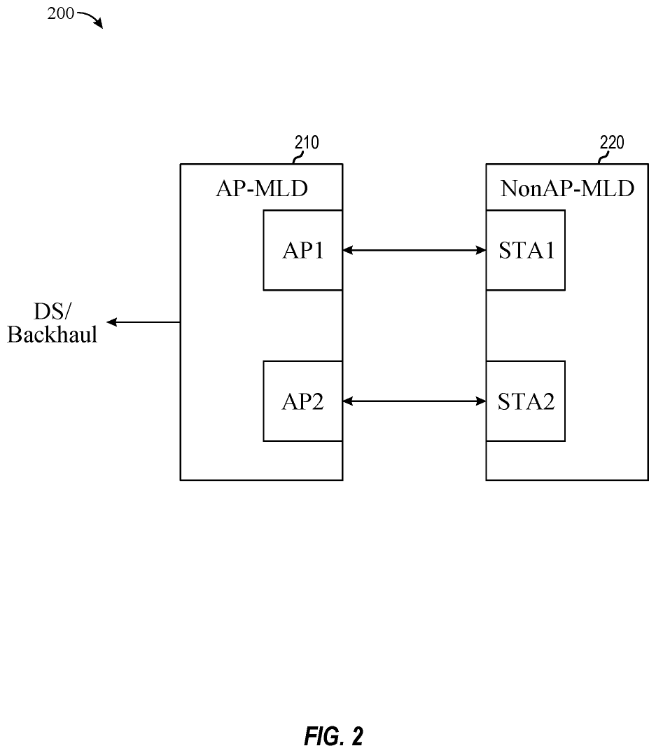

FIG. 2 depicts a block diagram of an example multi-link device (MLD) deployment.

As shown in FIG. 2, an access point (AP) MLD 202 may communicate with a non-AP MLD 204. Each of the AP MLD and non-AP MLD may include at least two STA entities 214 (hereinafter also referred to simply as “STAs”) that may communicate with associated STAs of another MLD. In an AP MLD, the STAs may be AP STAs 212 (STAs serving as APs or simply “APs”). In a non-AP MLD, the STAs may be non-AP STAs (STAs not serving as APs). As also described above, MLDs may utilize multi-link aggregation (MLA) (which includes packet level aggregation), whereby MPDUs from a same traffic ID (TID) may be sent via two or more wireless links.

Various modes of communication may be employed in MLD implementations. For example, a MLD may communicate in an Asynchronous (Async) mode or a Synchronous (Sync) mode. The Async mode provides flexibility to adapt to channel loading, allowing an MLD to perform channel access, transmit, and receive data via multiple links asynchronously. Sync mode may be preferred, however, if RF leakage exists between channels, because synchronized transmission on all links is unaffected by RF leakage.

In the Async mode, a STA/AP may count down (for example, via a random backoff (RBO)) on both wireless links. A physical layer convergence protocol (PLCP) protocol data units (PPDU) start/end may happen independently on each of the wireless links. As a result, Async mode may potentially provide latency and aggregation gains. In certain cases, relatively complex (and costly) filters may be needed (for example, in the case of 5 GHz+6 GHz aggregation).

In the Sync mode, a STA/AP may also perform a backoff countdown on multiple wireless links as part of a channel access procedure. If a first link gains access to the medium through the channel access procedure, multiple links may transmit PPDUs at the same time. Accordingly, this mode may need some restrictions to minimize in-device interference.

The Sync mode may work in 5 GHz+6 GHz aggregation and may require relatively low-filter performance, while still providing latency and aggregation gains. However, due to that STA's tiled architecture, this latency and aggregation gains may be hard to achieve.

Although not shown, a third mode of communication may include a Basic (for example, multi-primary with single link transmission) mode. In the Basic mode, a STA/AP may also count down on both wireless links. However, transmission may only occur on the wireless link that gains access to the medium. The other wireless link may be blocked by in-device interference greater than-62 decibels per milliwatt (dBm). No aggregation gains may be realized in this mode.

### Aspects Related to Hybrid Channel Management

Aspects of the present disclosure provide apparatuses, methods, processing systems, and computer-readable mediums for hybrid channel management, based on a service metric, to mitigate breach conditions.

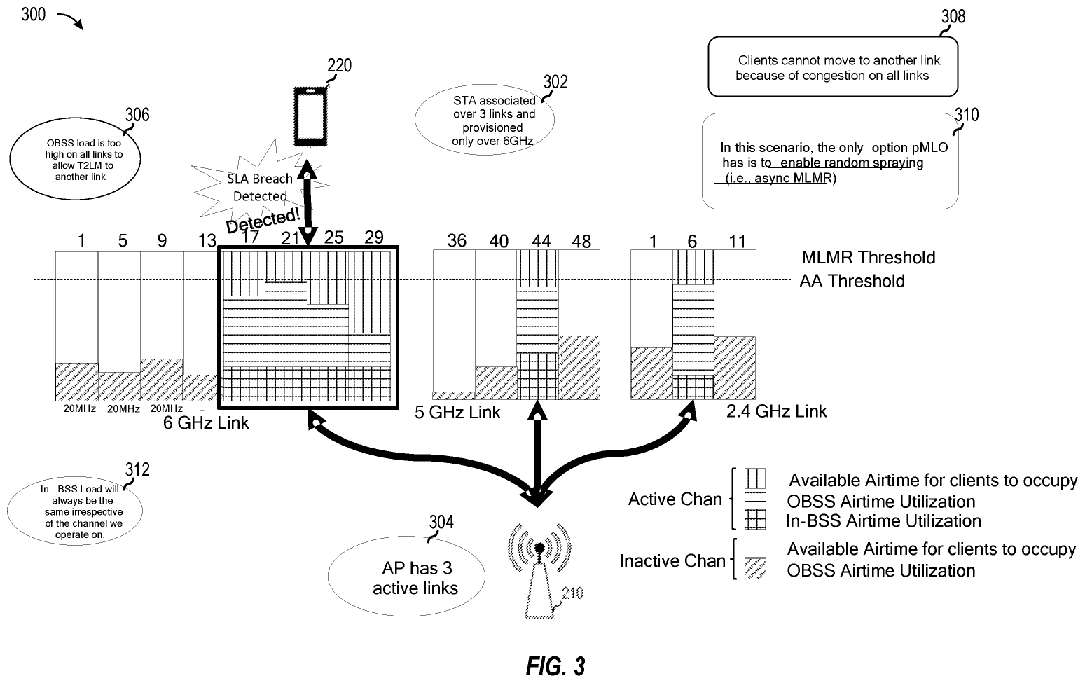

As noted above, a non-AP MLD may be provisioned to operate on only one link or a subset of links, rather than all available links. For example, FIG. 3 illustrates an example system 300 in which a non-AP MLD 220 (a client/STA) is provisioned by an AP MLD 210 to operate on a single link (6 GHz), even though the AP MLD is associated over 3 links of the AP MLD (2.4, 5, and 6 GHZ) as indicated at 302/304.

For example, the AP MLD may provision the non-AP MLD as shown by mapping all the traffic IDs (TIDs) to a particular link using TID to link mapping (T2LM). In the illustrated example, all TIDs are mapped to a channel (e.g., an 80 MHz channel with subchannels 17, 21, 25, and 29) of the 6 GHz link. Such provisioning may be performed, for example, for an SLA sensitive client based on a user application or a certain algorithm (e.g., for load-balancing or QoS-management).

Unfortunately, in some systems that provision clients in this manner, if a breach condition arises (e.g., an SLA breach that causes violation of an SLA obligation), there may be limited options to mitigate the breach condition. For example, the limited options may include an AP moving a client to another link (provided the new link can support the client with its available airtime).

However, as indicated at 306 and 308, in the illustrated example, OBSS loading is too high on all links to allow the AP to move to another link (via T2LM). Thus, as indicated at 310, the only available option may be to move the non-AP MLD 220 to an Multi-Link, Multi-Radio (MLMR) mode, which may lead to less than ideal transmissions across multiple links (random spraying).

In a high OBSS loaded environment, as in the illustrated example, these options alone may not be enough to provide adequate QoS and SLA guarantees to clients. This may be because a lack of available airtime (AA) may affect performance, irrespective of single link or multi-link operation. In this case, provisioning that restricts traffic to only a certain subset of links may not be able to manage the client QoS requirements effectively.

The hybrid channel management proposed herein, however, may provide greater flexibility and alternative options that may help mitigate breach conditions. For example, one additional option is to move the non-AP MLD to other channels within the same link (e.g., channels 1, 5, 9, and/or 13, which may have reduced OBSS loading (and/or additional available airtime) relative to current channels (e.g., active subchannels 17, 21, 25, and 29). Further, as indicated at 312, In-BSS loading may be the same, regardless of which channels the non-AP MLD is operating on.

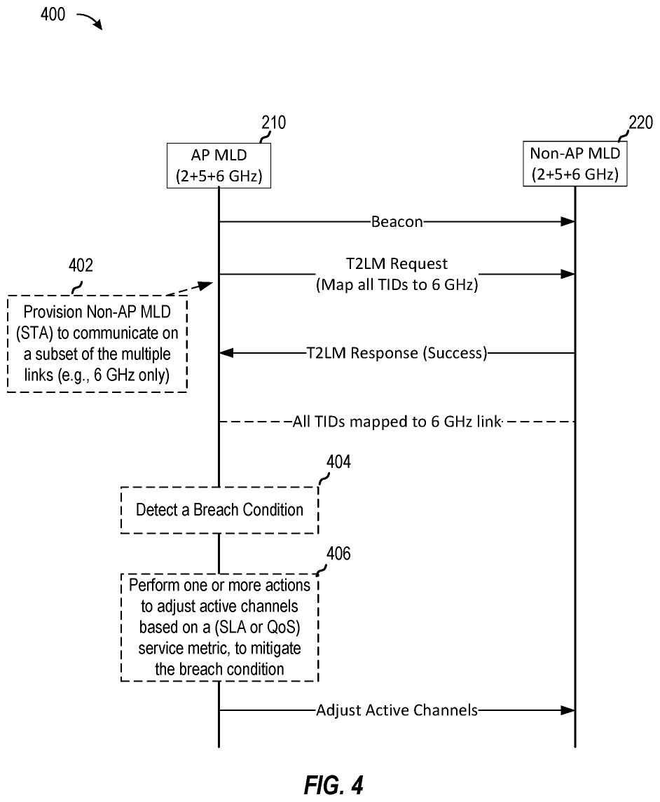

Hybrid channel management proposed herein may be understood with reference to the example call flow diagram 400 of FIG. 4. In some aspects, the AP-MLD device 210 and Non-AP MLD device 220 depicted in FIG. 4 may be examples of the AP-MLD 210 and Non AP-MLD 220 depicted and described with respect to FIG. 2.

As illustrated at 402, the AP MLD may provision the non-AP MLD to communicate on a subset of the multiple links (e.g., 6 GHz only). The provisioning may be achieved via a T2LM request to map all TIDs to 6 GHZ, which may be acknowledged by the non-AP MLD via a T2LM Response.

As illustrated at 404, the AP MLD detects a breach condition after all TIDS are mapped to the 6 GHz link. As illustrated at 406, the AP MLD may perform one or more actions to adjust channels based on a (SLA or QoS) service metric, to mitigate the breach condition.

As an example, if the congestion on a link is dominated by OBSS channel loading, then an AP (AP MLD) may attempt to operate more effectively by changing the channel on one or more links of the MLD to ones that have lower OBSS channel loading (and sufficiently high airtime availability).

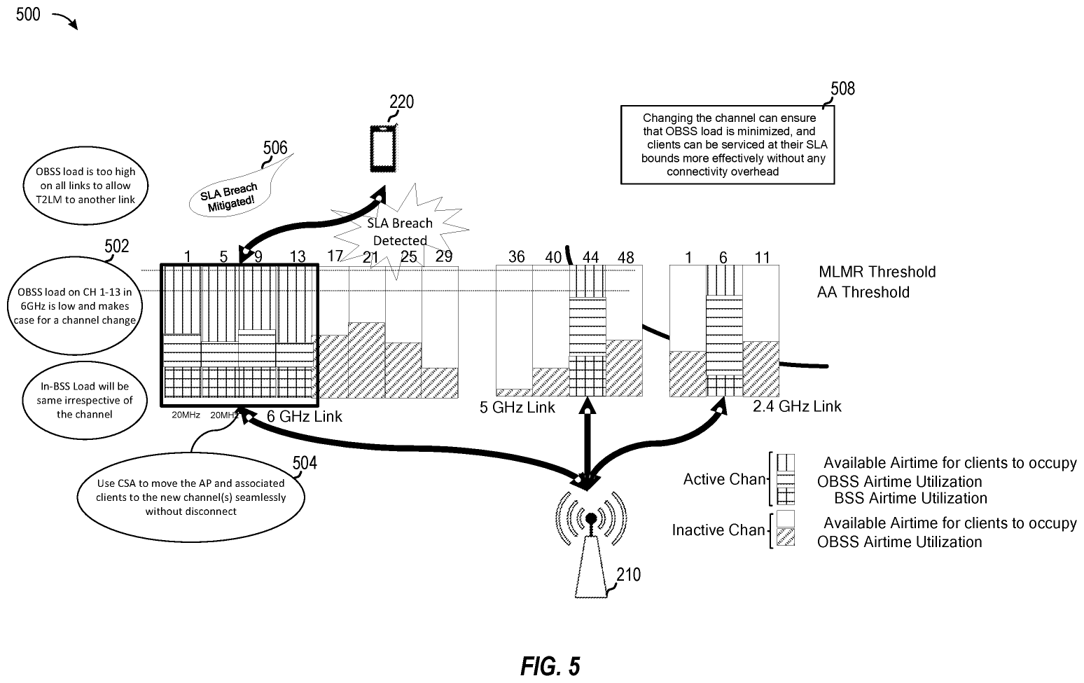

This scenario is illustrated in the example diagram 500 of FIG. 5. In the illustrated example, upon detecting a breach (e.g., related to Available Airtime, SLA, aMLMR, . . . ), an AP MLD 210 may attempt to look beyond client link assignments and implement what may be considered a client-aware channel management scheme. In some cases, the client-aware channel management scheme may be implemented alongside other link allocation strategies.

For example, as illustrated at 502, the AP MLD may determine that OBSS loading on channels 1-13 in the 6 GHz link is low. Therefore, as indicated at 504, the AP MLD may use a channel switch announcement (CSA) mechanism to move the AP and associated clients (from channels 17-29) to the new channel(s) seamlessly without disconnect.

As indicated at 506, this move may help mitigate the SLA breach. For example, as indicated at 508, changing the channel(s) may help ensure that OBSS load is minimized. This may help ensure that clients can be serviced at their SLA bounds more effectively without any connectivity overhead.

This client-aware approach to channel management may be different from conventional state-of-the-art triggers to channel selection which are based on, for example, radar, interference detection, or mesh-based best channel resolution across multiple nodes. Channel selection based on these considerations would not prioritize quality-of-service or SLA of a client alongside channel conditions when picking a new channel.

In contrast, conventional channel selection algorithms might pick a channel with link quality and OBSS count. Aspects of the present disclosure, however, may consider real time In-BSS loading of the AP clients on the environment, for example, based on QoS class alongside link quality. This client-aware approach may be made possible within a provisioned MLO (pMLO) statistics framework.

For example, upon detecting a congestion breach, congestion reduction may be carried out by searching for a better BSS channel, in terms of lower OBSS loading for a client's current link, or for any of the other links the client is associated on, which can handle the client's airtime utilization (AU).

In some cases, upon detecting an SLA breach, a pMLO enabled AP MLD may analyze the cause for missing (violating) the SLA for a client by checking to see if OBSS loading is the reason. If OBSS loading is the reason for the breach, the AP MLD may initiate a channel selection algorithm on one or more links the client is connected on, which can handle the client's airtime utilization.

In some cases, channel selection may be carried out with the help of a Channel Switch Announcement (CSA) field in a beacon in order to allow seamless transition to the new channel on one or more links. In some cases, if configured, a client may move to MLMR (if not already in aMLMR mode) before completing the CSA, so that the client may also leverage other links in order to send out traffic during a timeout (TO) period incurred during internal reset sequences.

As described herein, based on the airtime utilization of a client (which may be a function of the QoS requirement for a STA), an AP MLD may try to take corrective actions beyond simply moving between static links and/or enabling random spraying. There are various other possible actions that may be performed, as an alternative or in addition to channel changing, to enhance a pMLO deployment. For example, the other possible actions may include resource unit (RU) puncturing, reducing bandwidth, a change in links plus channels, and/or an intra-ESS and mesh node handover.

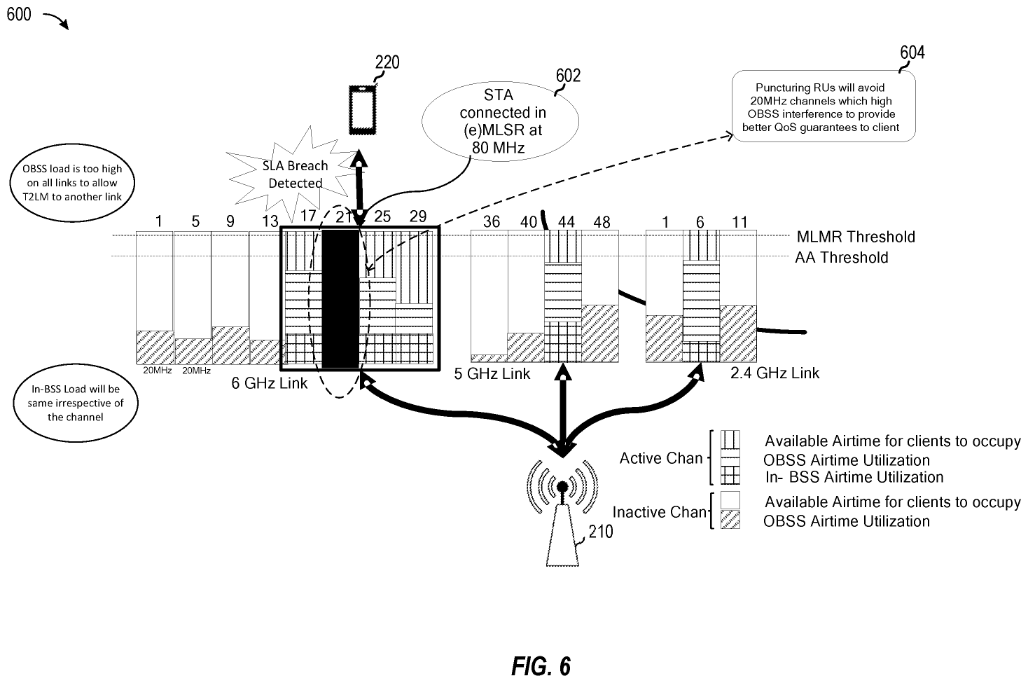

Diagram 600 of FIG. 6 illustrates an example of RU puncturing, in accordance with aspects of the present disclosure. As indicated at 602, the example assumes non-AP MLD is connected in (e) MLSR at 80 MHz (on 4 20 MHz channels 17, 21, 25, and 29) when an SLA breach is detected. Statically puncturing certain 20 MHz sub-channels from the operating bandwidth which contribute to higher OBSS load can be excluded from transmission, effectively sacrificing RUs for better QoS, such as latency and reliability. As indicated at 604, in the illustrated example, puncturing RUs will avoid 20 MHz channels with high OBSS interference (20 MHz channel 21) in an effort to provide better QoS guarantees to client.

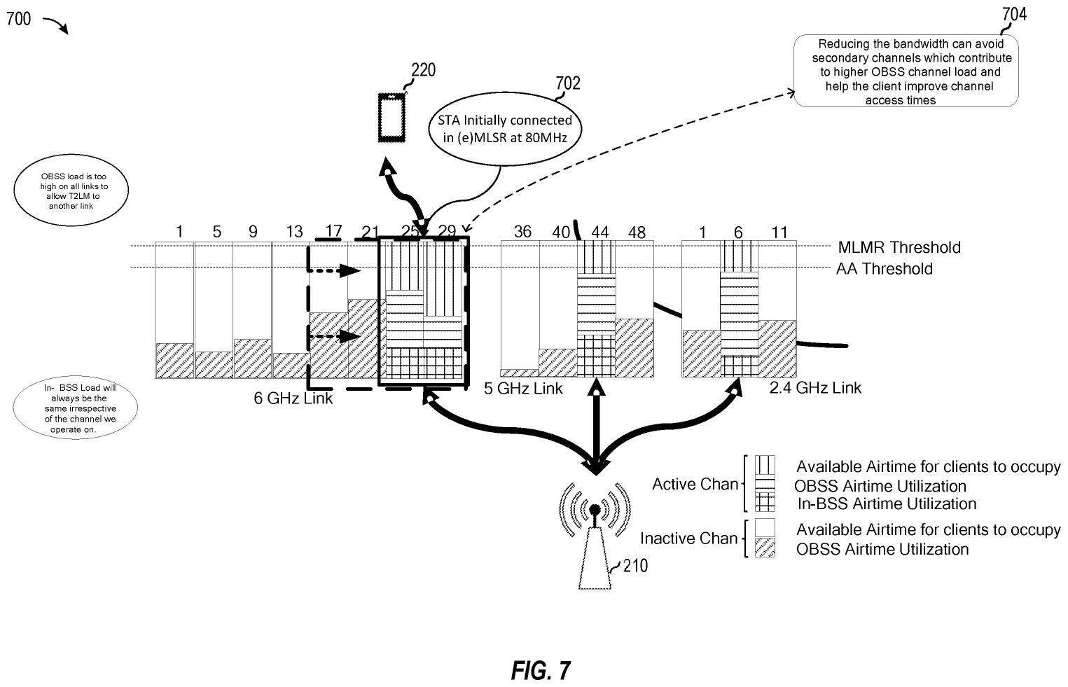

Diagram 700 of FIG. 7 illustrates an example of bandwidth reduction. As indicated at 702, the example assumes the non-AP MLD (STA) is initially connected in (e) MLSR at 80 MHz. As indicated at 704, the bandwidth is reduced so that secondary channels which contribute to higher OBSS loading (20 MHz channels 17 and 21) can be excluded from transmission, effectively, sacrificing bandwidth in exchange for better QoS.

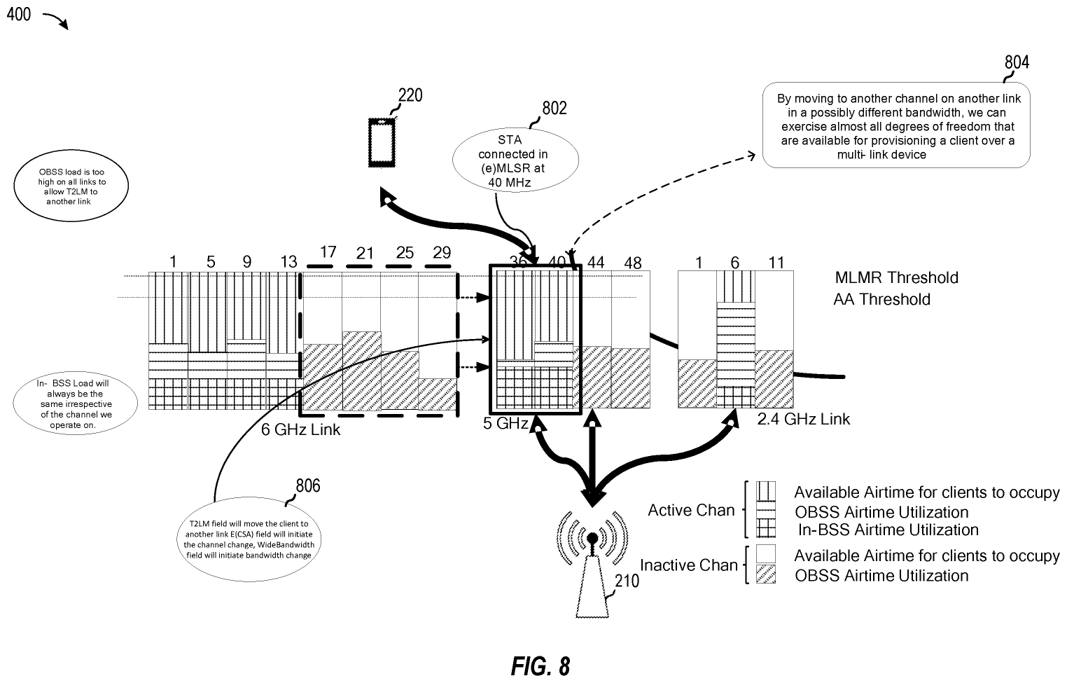

Diagram 800 of FIG. 8 illustrates an example of a change in link plus channel. The example assumes the non-AP MLD was initially connected at 80 MHZ before the change. As indicated at 802, after the change, the non-AP MLD is connected in (c) MLSR at 40 MHz (on 20 MHz channels 36 and 40 of the 5 GHz link). As indicated at 804, by moving to another channel on another link in a possibly different bandwidth, we can exercise almost all degrees of freedom that are available for provisioning a client over a multi-link device.

As indicated at 806, in some cases, the AP MLD may move the non-AP MLD to the new link (5 GHZ) with a T2LM field while also initiating a CSA on the new link to move to a better channel which can serve the client set for the link. For example, a T2LM field may move the non-AP MLD to another link, while a (c) CSA field may initiate the channel change (and a wide bandwidth field will initiate bandwidth change).

In some cases, if none of the channels in any of the links are able to satisfy the SLA of a given client, then the AP MLD may check if there are any other BSSs within the ESS or mesh network that are able support the client's SLA. If so, the AP MLD may initiate a handover. In such cases, the other BSS may be at an extended range but may still be able to support better low latency communication at the cost of reduced data rates.

In some cases, to determine OBSS load on foreign channels while AP and STA are operating in over the current channel, an AP-MLD may generate a list of scanning results to evaluate when determining a suitable (best) channel to operate on. This type of channel determination be performed according to various options.

According to a first option, a background scanning algorithm may be used. In some cases, an AP may continuously run background scanning on foreign (OBSS) channels in small time slices, to ensure beacon scheduling and avoid wasting transmission opportunities (TXOPs) to its clients on the home channel. As a result of scanning based on smaller time slices, only a few channels may be scanned each slice and the scan time may be multiple orders longer and would also lead to slightly inaccurate scan results in a highly dynamic environment. Additionally, because the AP goes to the foreign channels, albeit in smaller slices, it may have a cost in terms of missed transmission opportunities on the home channel resulting in a throughput overhead.

According to a second option, an efficient decentralized radio measurement algorithm may be used. In such cases, an AP may allocate a full channel list for each link to its corresponding clients connected over each of those links. The allocation may be performed in a way that each client over each link will scan a subset of channels on a trigger from the AP (e.g., through 802.11k-based radio measurement statistics). This decentralized approach may help reduce the overhead of foreign channel scanning on a client without too much power usage overhead, while also allowing multiple parallel scans to happen to reduce the scan time for faster convergence.

According to a third option, a dedicated radio may be used for scanning. Having a dedicated radio to scan for better channels across one or more bands may help avoid the need for an AP to move to foreign channels and reduce transmission times to its clients. This increase in performance may justify the cost of additional hardware.

According to a fourth option, multi-link operation (MLO) may be used for scanning. One potential reason why scanning may be difficult during runtime is the overhead of moving to foreign channels while having clients connected. In such cases, the AP may need to remain in the home channels during beacon scheduling as well as to maximize their transmission opportunities to their client set.

One potential of using MLO for scanning is to leverage T2LM to move clients to MLMR, if applicable, or to another link in provisioned mode entirely for the period of the scan. This approach may be understood by considering a 3-link MLD on an AP (e.g., 2.4 GHz, 5 GHz, 6 GHz as in the examples described above). When an AP decides to scan for a better channel on any of the links, it may need to gather scan results. In such cases, the AP may need to start scanning on one or more channels.

Assuming that the AP decides to scan all three channels in the worst case, it may be beneficial for the AP to do it iteratively (one-by-one). For example, the AP may start with the 2.4 GHz link and send a T2LM mapping to move clients to another link or force them in aMLMR and disable the 2.4 GHz link client. The AP may then scan the 2.4 GHz link effectively over a maximum scan time without worrying about client connectivity on the 2.4 GHz link, since they are operating on other links.

On completion of scanning on the 2.4 GHz link the AP may move to the next round of scanning in the 5 GHz link. Thus, the AP may move clients on the 5 GHz link to the other links or enable aMLMR and disable the 5 GHz link client. The AP may perform the same procedure to scan channels on the 6 GHz link. After completing scanning in each link the AP may bring the client distribution back to the original state before the scanning took place.

One potential challenge of an MLO based channel scanning algorithm is that it may assume that all clients are MLO capable and will have alternative links to manage clients. If non-MLO capable (so called legacy) clients are connected to the AP on scanning links, then the AP/clients may lose connectivity. In such a case, an AP may only need to serve the legacy clients during scanning, which it may be able to do, for example, by modifying the foreign channel scan time to be lower and increasing the beacon interval to the clients so as to continue scanning but also continue serving the smaller set of legacy clients on that link.

The client-aware channel management proposed herein may allow an AP to efficiently operate, with another degree of freedom to maintain provisioning of all its clients. As described herein, in OBSS heavy traffic, the AP may be able to improve the airtime availability by moving to another channel instead of keeping the links in a bad/high interference channel due to natural dynamicity of the wireless medium. Using the techniques proposed herein, random spraying probability may be reduced and overall network optimization may be improved, since it may be possible to seamlessly change the channel as part of the pMLO operation before moving to asynchronous MLMR.

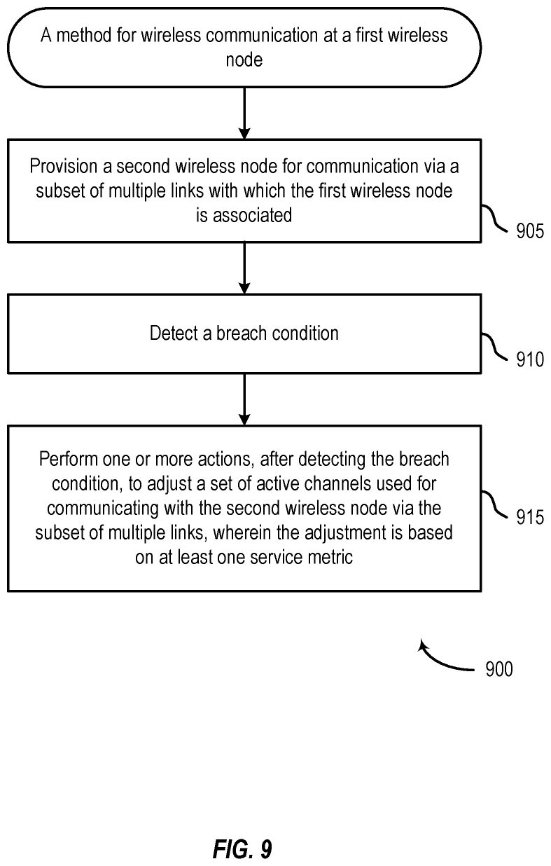

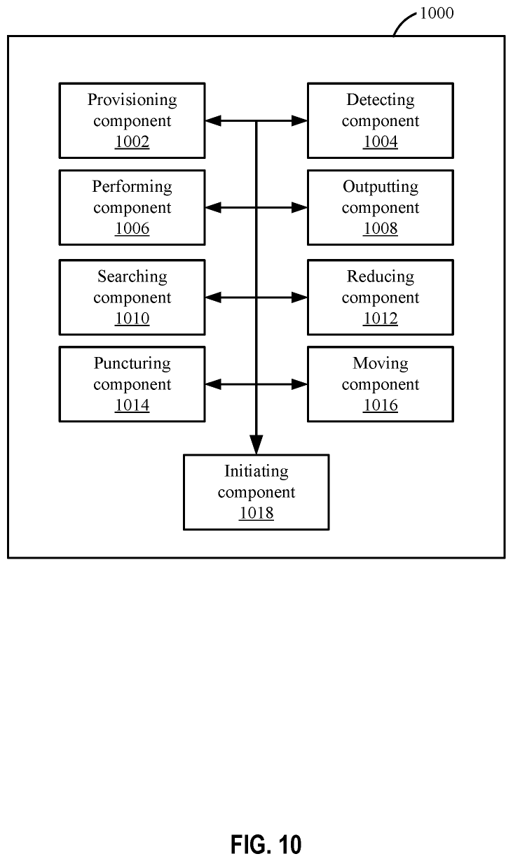

FIG. 9 shows a flowchart illustrating an example process 900 performable at a first wireless node, according to certain aspects of the present disclosure. The operations of the process 900 may be implemented by a wireless AP or a wireless STA, or its components as described herein. For example, the process 900 may be performed by a wireless communication device, such as the wireless communication device 1000 described with reference to FIG. 10, operating as or within a wireless AP or a wireless STA. In some examples, the process 900 may be performed by a wireless AP or a wireless STA, such as one of the wireless APs 102 or one of the wireless STAs 104 described with reference to FIG. 1.

Process 900 begins at step 905 with provisioning a second wireless node for communication via a subset of multiple links in which the first wireless node is associated.

Process 900 then proceeds to step 910 with detecting a breach condition.

Process 900 then proceeds to step 915 with performing one or more actions, after detecting the breach condition, to adjust a set of active channels used for communicating with the second wireless node via the subset of multiple links, wherein the adjustment is based on at least one service metric.

In one aspect, process 900, or any aspect related to it, may be performed by an apparatus, such as communications device 1000 of FIG. 10, which includes various components operable, configured, or adapted to perform the process 900. Communications device 1000 is described below in further detail.

Note that FIG. 9 is just one example of a method, and other methods including fewer, additional, or alternative steps are possible consistent with this disclosure.

FIG. 10 shows a block diagram of an example wireless communication device 1000 that supports techniques disclosed herein, such as techniques that enable a network entity to indicate recommendations, to a wireless station, for seamless roaming. In some examples, the wireless communication device 1000 is configured to perform the process 900 described with reference to FIG. 9. The wireless communication device 1000 may include one or more chips, SoCs, chipsets, packages, components or devices that individually or collectively constitute or comprise a processing system. The processing system may interface with other components of the wireless communication device 1000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 1000 may transmit the information output from the chip. In such an example, the second interface may refer to an interface between the processing system of the chip and a reception component, such that the device 1000 may receive information that is then passed to the processing system. In some such examples, the first interface also may obtain information, such as from the transmission component, and the second interface also may output information, such as to the reception component.

The processing system of the wireless communication device 1000 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1000 can be configurable or configured for use in an AP or a STA, such as the AP 102 or the STA 104 described with reference to FIG. 1. In some other examples, the wireless communication device 1000 can be an AP or a STA that includes such a processing system and other components including multiple antennas. The wireless communication device 1000 is capable of transmitting and receiving wireless communications in the form of, for example, wireless packets. For example, the wireless communication device 1000 can be configurable or configured to transmit and receive packets in the form of physical layer PPDUs and MPDUs conforming to one or more of the IEEE 802.11 family of wireless communication protocol standards. In some other examples, the wireless communication device 1000 can be configurable or configured to transmit and receive signals and communications conforming to one or more 3GPP specifications including those for 5G NR or 6G. In some examples, the wireless communication device 1000 also includes or can be coupled with one or more application processors which may be further coupled with one or more other memories. In some examples, the wireless communication device 1000 further includes at least one external network interface coupled with the processing system that enables communication with a core network or backhaul network that enables the wireless communication device 1000 to gain access to external networks including the Internet.

The wireless communication device 1000 includes a provisioning component 1002, a detecting component 1004, a performing component 1006, an outputting component 1008, a searching component 1010, a reducing component 1012, a puncturing component 1014, a moving component 1016, and an initiating component 1018. Portions of one or more of the components 1002, 1004, 1006, 1008, 1010, 1012, 1014, 1016, and 1018 may be implemented at least in part in hardware or firmware. For example, the obtaining component 1006 may be implemented at least in part by a processor or a modem. In some examples, portions of one or more of the components 1002, 1004, 1006, 1008, 1010, 1012, 1014, 1016, and 1018 may be implemented at least in part by a processor and software in the form of processor-executable code stored in a memory.

In some implementations, the processor may be a component of a processing system. A processing system may generally refer to a system or series of machines or components that receives inputs and processes the inputs to produce a set of outputs (which may be passed to other systems or components of, for example, the wireless communication device 1000). For example, a processing system of the wireless communication device 1000 may refer to a system including the various other components or subcomponents of the wireless communication device 1000, such as the processor, or a transceiver, or a communications manager, or other components or combinations of components of the wireless communication device 1000. The processing system of the wireless communication device 1000 may interface with other components of the wireless communication device 1000, and may process information received from other components (such as inputs or signals) or output information to other components. For example, a chip or modem of the wireless communication device 1000 may include a processing system, a first interface to output information and a second interface to obtain information. In some implementations, the first interface may refer to an interface between the processing system of the chip or modem and a transmitter, such that the wireless communication device 1000 may transmit information output from the chip or modem. In some implementations, the second interface may refer to an interface between the processing system of the chip or modem and a receiver, such that the wireless communication device 1000 may obtain information or signal inputs, and the information may be passed to the processing system. A person having ordinary skill in the art will readily recognize that the first interface also may obtain information or signal inputs, and the second interface also may output information or signal outputs.

### Example Clauses

Implementation examples are described in the following numbered clauses:
Clause 1: A method for wireless communication at a first wireless node, comprising provisioning a second wireless node for communication via a subset of multiple links with which the first wireless node is associated, detecting a breach condition, and performing one or more actions, after detecting the breach condition, to adjust a set of channels used for communicating with the second wireless node via the subset of multiple links, wherein the adjustment is based on at least one service metric.
Clause 2: The method of Clause 1, wherein the at least one service metric relates to at least one of: a quality of service (QOS) metric or a service level agreement.
Clause 3: The method of any one of Clauses 1-2, wherein the one or more actions comprise switching the communication with the second wireless node to at least one new channel, wherein the at least one new channel comprises at least one of: a first new channel within the subset of multiple links; or a second new channel within a link outside of the subset.
Clause 4: The method of any one of Clauses 1-3, wherein at least one of: the breach condition relates to congestion associated with at least one currently active link; or the one or more actions comprise searching for one or more channels with less congestion than the congestion associated with the at least one currently active link.
Clause 5: The method of any one of Clauses 1-4, wherein at least one of: the breach condition relates to potential violation of a service level agreement (SLA) involving the at least one service metric; or the one or more actions comprise searching for one or more channels that can satisfy the SLA.
Clause 6: The method of any one of Clauses 1-5, wherein the at least one service metric relates to airtime utilization of the second wireless node.
Clause 7: The method of any one of Clauses 1-6, wherein the one or more actions comprise at least one of: reducing operating bandwidth to exclude one or more channels which contribute to other basic service set (OBSS) loading; resource unit puncturing on one or more channels that contribute to OBSS loading; or moving the second wireless node to a new link and announcing a channel switch on the new link.
Clause 8: An apparatus, comprising: at least one memory comprising executable instructions; and at least one processor configured to execute the executable instructions and cause the apparatus to perform a method in accordance with any one of Clauses 1-7.
Clause 9: An apparatus, comprising means for performing a method in accordance with any one of Clauses 1-7.
Clause 10: A non-transitory computer-readable medium comprising executable instructions that, when executed by at least one processor of an apparatus, cause the apparatus to perform a method in accordance with any one of Clauses 1-7.
Clause 11: Access point multi-link device (AP MLD), comprising: at least one transceiver; at least one memory comprising executable instructions; and at least one processor configured to execute the executable instructions and cause the AP MLD to perform a method in accordance with any one of Clauses 1-7, wherein the at least one transceiver is configured to communicate with the second wireless node via the subset of multiple links.

### Additional Considerations

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

Means for provisioning, means for detecting, means for performing one or more actions, means for switching, means for reducing, means for puncturing, means for moving, means for initiating, means for background scanning, means for obtaining, and means for mapping may comprise one or more processors/components, such as one or more of the processors/components described above with reference to FIG. 10.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus for wireless communication, comprising:
at least one memory comprising computer-executable instructions; and
one or more processors configured to execute the computer-executable instructions and cause the apparatus to:
provision a wireless node for communication via a subset of multiple links with which a first wireless node is associated;
detect a breach condition; and
perform one or more actions, after detecting the breach condition, to adjust a set of channels used for communicating with the wireless node via the subset of multiple links, wherein the adjustment is based on at least one service metric.

2. The apparatus of claim 1, wherein the at least one service metric relates to at least one of: a quality of service (QOS) metric or a service level agreement.

3. The apparatus of claim 1, wherein the one or more actions comprise switching the communication with the wireless node to at least one new channel, wherein the at least one new channel comprises at least one of:
a first new channel within the subset of multiple links; or
a second new channel within a link outside of the subset.

4. The apparatus of claim 1, wherein at least one of:
the breach condition relates to congestion associated with at least one currently active link; or
the one or more actions comprise searching for one or more channels with less congestion than the congestion associated with the at least one currently active link.

5. The apparatus of claim 1, wherein at least one of:
the breach condition relates to potential violation of a service level agreement (SLA) involving the at least one service metric; or
the one or more actions comprise searching for one or more channels that can satisfy the SLA.

6. The apparatus of claim 1, wherein the at least one service metric relates to airtime utilization of the wireless node.

7. The apparatus of claim 6, wherein the one or more actions comprise at least one of:
reducing operating bandwidth to exclude one or more channels which contribute to other basic service set (OBSS) loading;
resource unit puncturing on one or more channels that contribute to OBSS loading; or
moving the wireless node to a new link and announcing a channel switch on the new link.

8. The apparatus of claim 1, wherein the one or more actions comprise:
initiating a handover of the wireless node, from a first basic service set (BSS) to a second BSS if channels in the first BSS are unable to satisfy a service level agreement (SLA) involving the at least one service metric.

9. The apparatus of claim 1, wherein performing one or more actions to adjust the set of channels is based on results of a scanning algorithm to determine other basic service set (OBSS) loading on secondary channels outside the set of channels.

10. The apparatus of claim 9, wherein the scanning algorithm involves at least one of:
background scanning of secondary channels in time slices;
obtaining radio measurements of secondary channels from one or more other wireless nodes; or
an auxiliary radio that is separate from a radio used for communicating with the wireless node.

11. The apparatus of claim 9, wherein the scanning algorithm involves:
moving one or more wireless nodes from a first link of the multiple links;
scanning channels of the first link after the moving; and
moving the one more wireless nodes back to the first link after the scanning.

12. The apparatus of claim 11, wherein the moving the one or more wireless nodes from and back to the first link involves traffic identifier (TID) to link mapping.

13. A method for wireless communication at a first wireless node, comprising:
provisioning a second wireless node for communication via a subset of multiple links with which the first wireless node is associated;
detecting a breach condition; and
performing one or more actions, after detecting the breach condition, to adjust a set of channels used for communicating with the second wireless node via the subset of multiple links, wherein the adjustment is based on at least one service metric.

14. The method of claim 13, wherein the at least one service metric relates to at least one of: a quality of service (QOS) metric or a service level agreement.

15. The method of claim 13, wherein the one or more actions comprise switching the communication with the second wireless node to at least one new channel, wherein the at least one new channel comprises at least one of:
a first new channel within the subset of multiple links; or
a second new channel within a link outside of the subset.

16. The method of claim 13, wherein at least one of:
the breach condition relates to congestion associated with at least one currently active link; or
the one or more actions comprise searching for one or more channels with less congestion than the congestion associated with the at least one currently active link.

17. The method of claim 13, wherein at least one of:
the breach condition relates to potential violation of a service level agreement (SLA) involving the at least one service metric; or
the one or more actions comprise searching for one or more channels that can satisfy the SLA.

18. The method of claim 13, wherein the at least one service metric relates to airtime utilization of the second wireless node.

19. The method of claim 18, wherein the one or more actions comprise at least one of:
reducing operating bandwidth to exclude one or more channels which contribute to other basic service set (OBSS) loading;
resource unit puncturing on one or more channels that contribute to OBSS loading; or
moving the second wireless node to a new link and announcing a channel switch on the new link.

20. An access point multi-link device (AP MLD), comprising:
at least one transceiver;
at least one memory comprising computer-executable instructions; and
one or more processors configured to execute the computer-executable instructions and cause the AP MLD to:
provision a wireless node for communication via a subset of multiple links with which the AP MLD is associated;
detect a breach condition; and
perform one or more actions, after detecting the breach condition, to adjust a set of channels used for communicating with the wireless node via the subset of multiple links using the at least one transceiver, wherein the adjustment is based on at least one service metric.
